(19) United States
(12) Patent Application Publication
(10) Pub. No.: US 2022/0373015 A1
(43) Pub. Date: Nov. 24, 2022

(54) Fixed Engagement Anchor

(71) Applicant: Rudor M. Teich, West Orange, NJ (US)

(72) Inventor: Rudor M. Teich, West Orange, NJ (US)

(21) Appl. No.: 17/508,061

(22) Filed: Oct. 22, 2021

Related U.S. Application Data
(60) Provisional application No. 63/258,643, filed on May 19, 2021.

(51) Int. Cl. F16B 25/00

(52) U.S. Cl. CPC F16B 25/0036

(57) ABSTRACT

A novel plastic anchor design allows for the use of a wide range of thread-cutting screw lengths without exceeding the recommended engagement length. In accordance with the principles disclosed herein, an anchor comprises an engagement area and a relief chamber. The anchor is configured to be secured into a surrounding material. The engagement area is configured to engage with a screw to secure the screw when fastening an object in place. The relief chamber receives any excess length of the screw that extends beyond the engagement area. This allows the length of engagement between the screw and the anchor to be controlled for various lengths of screws or thicknesses of objects to be fastened.

### CROSS-REFERENCE TO RELATED APPLICATION

This application claims the benefit of U.S. Patent App. No. 63/258,643, filed on May 19, 2021.

### BACKGROUND

Anchoring devices are devices that facilitate attaching objects, including structures, to a surface. The surface can be at any angle, including for example vertical or horizontal. Examples of anchor applications are mounting pictures to a wall or attaching bike racks to an asphalt surface.

While anchoring devices (hereafter referred to as “anchors”) can be manufactured from various materials, the principles disclosed herein are particularly useful for anchors made primarily from plastic. Plastic anchors tend to be less expensive to manufacture than anchors made of other materials and allow complex designs that can be economically incorporated when the anchors are being molded.

Anchors require a screw or a bolt (hereafter referred to as “screw”) to clamp the attached object to the anchor body. The screw threads into the anchor body and is tightened to secure the object to the anchor. Examples of screws include a machine screw or a thread-forming screw. Machine screws require a matching thread to be pre-formed internal to the anchor. Thread forming screws need only a simple hole in the anchor, such that when the screw is first threaded into the anchor, the screw bites into the plastic and forms its own thread. FIG. 1 shows a thread forming screw in use with a plastic anchor intended for use for sheetrock walls. FIG. 2 shows an expanding anchor used with a lag bolt for use on concrete surfaces.

Thread-forming screws require torque to force their way into the plastic. The length of the anchor that is in contact with the screw is called “length of engagement” and is defined as the length of the full threads that are in contact with the plastic. FIG. 3 depicts the length of engagement for screw 300, which holds clamped item 302 against surface material 304. The longer the engagement, the more torque is required. This increasing torque can damage the anchor, break the screw, or break the hold of the anchor on its surrounding area (“torque-out”), any of which can cause the anchor to fail.

The current method of limiting the drive torque is to limit the length of engagement. Length of engagement is often expressed in relationship to the nominal diameter of the screw. For example, an engagement of 2 for a 6 mm screw means that the length of the engagement is 12 mm. A recommended engagement is 2 to 2.5. Any higher number will not increase the pull resistance of the screw out of the anchor but may damage the anchor or its installation.

This limitation of the engagement ratio is not a problem in assembly lines, as the screw length can be selected to match the requirement. However, in field applications, this limited range of allowed engagement may present a difficulty because the anchors will need to be supplied with the suitable screws in kit form. While the length of engagement is constant, various screw lengths are needed to accommodate various thicknesses of the clamped items. If the anchor is to accommodate a range of clamping thicknesses, several screws with varying length would have to be provided. The need to include screws of various lengths materially raises the cost of the anchor kit.

In one example, an 8 mm anchor needs to accommodate mounting plates with thickness ranging from 2 mm to 12 mm in thickness. Using engagement of 2, the screw length would have to be between 18 mm and 28 mm. If the anchor is shipped with the largest screw (28 mm) and the item to be anchored is only 2 mm thick, the engagement would be 22 mm instead of the recommended 16 mm. The extra length will make driving the screw that much harder and may damage the installed anchor.

Machine screws are an alternative to the use of thread-forming screws in plastic anchors. Machine screws are readily available at a fraction of the cost of thread-forming screws for plastic. Limiting their use is the poor pull-out performance of molded machine threads in plastic, due to the shallow depth of the thread. Thus, to accommodate a machine screw, the anchor needs to include a threaded metal sleeve insert that is molded into the internal chamber of the anchor.

If there is a need to allow the use of long screws to accommodate a range of thicknesses in the object to be clamped to the anchor, as is the case with plastic anchors for thread forming screws, a known solution is to use a long metal insert. Such an insert is expensive. The cost of a metal insert and the complexity of molding it into the plastic increases the manufactured cost of the anchor significantly above the cost of an anchor that can accommodate a thread-cutting screw.

An anchor grips the material it is surrounded by (the “substrate”) either by friction or by using an adhesive. The anchor depicted in FIG. 1 is threaded into the sheetrock and thus is held in place through the friction of the spiral cutting into the sheetrock.

The anchor in FIG. 2 expands as the screw is tightened and thus applies pressure to the walls of the hole in the concrete. This pressure causes friction that prevents the anchor from being pulled out.

FIG. 4 shows a chemical anchor installed in asphalt. An oversize hole is drilled in the asphalt and filled with an adhesive (identified as “grout” in the rendering). The cured grout binds to the anchor on the one side and to the asphalt on the other. Asphalt being relatively soft and yielding negates the use of friction as a means of holding the anchors in place. Use of adhesive is stress free and assures that the anchor stays reliably installed.

Chemical anchors must be sealed to prevent the adhesive from penetrating the internal thread of the screw, or else the screw will not be able to be withdrawn or tightened to clamp the attached object. This eliminates the use of an expanding anchor, such as the expanding anchor shown in FIG. 2, because the anchor does not fully encase the thread and thus the screw and the internal thread of the anchor would be overrun by the adhesive.

The resistance of an installed anchor to axial pull forces is the lower of the resistance of the screw to pull-out from the anchor, and the resistance of the anchor body to pulling out of the substrate. The principles disclosed herein enhance the screw pull-out resistance. Henceforth, “pull-out” will pertain exclusively to the ability of the anchor to hold on to the screw against axial forces.

Reference is made to a publication by Stanley Black & Decker, Inc. entitled “Engineered Threaded Fasteners for Plastics” (PTF FFP, Rev 09, 2015) (“the Stanley Publication”) which details the design, use and application of its line of for-plastic thread-forming screws. A section in page 6 titled “Thread forming and Stripping Torque” teaches that “Because friction increases as penetration increases, the differential between the thread forming torque and the strip (failure) torque must be maximized.” Much of the Stanley Publication deals with the compromises required between increasing pull-out resistance by having a tight fit between the screw and the plastic, and the danger of strip-out when forming the thread. Strip-out means that the high torque required to form the thread will damage the threads already made, at which point the screw will break away from the already-formed thread and rotate freely.

The Stanley Publication defines a Drive-To-Strip Ratio as the ratio of the torque required to strip the thread, divided by the torque required to drive the screw into the plastic. A ratio of 4 is considered a good value. This ratio drops quickly as the length of engagement increases above the recommended value (the Stanley Publication advises that the length of engagement should be 2 to 3 times the nominal screw diameter). The indication is that, even under best conditions, a plastic thread can easily strip if the engagement length is not controlled properly.

Thus, there exists a need for an anchor that provides a fixed maximum engagement length for a variety of screw lengths. There also exists a need for an anchor that is sealed and can be used as a chemical anchor. There also exists a need for an anchor that can use a short-threaded insert yet can accommodate varying lengths of screws.

### SUMMARY

In accordance with the principles disclosed herein, an anchor comprises an engagement area and a relief chamber. The anchor is configured to be secured into a surrounding material. The engagement area is configured to engage with a screw to secure the screw when fastening an object in place. The relief chamber receives any excess length of the screw that extends beyond the engagement area. This allows the length of engagement between the screw and the anchor to be controlled for various lengths of screws or thicknesses of objects to be fastened.

### BRIEF DESCRIPTION OF THE DRAWINGS

The detailed description makes reference to the accompanying figures wherein:

FIG. 1 illustrates a thread-forming screw and a plastic anchor in accordance with the prior art.

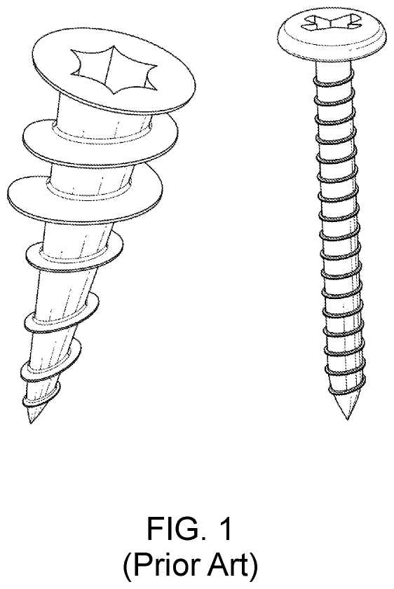

FIG. 2 illustrates a prior art expanding anchor used with a lag bolt.

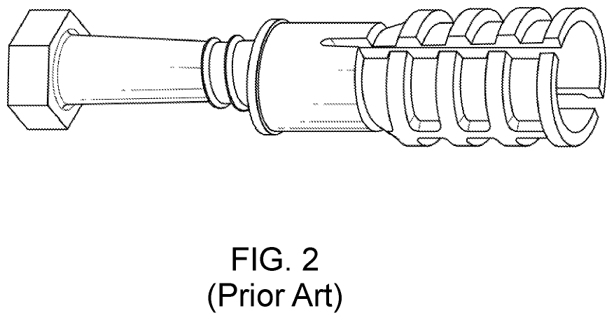

FIG. 3 illustrates a prior art thread-forming screw.

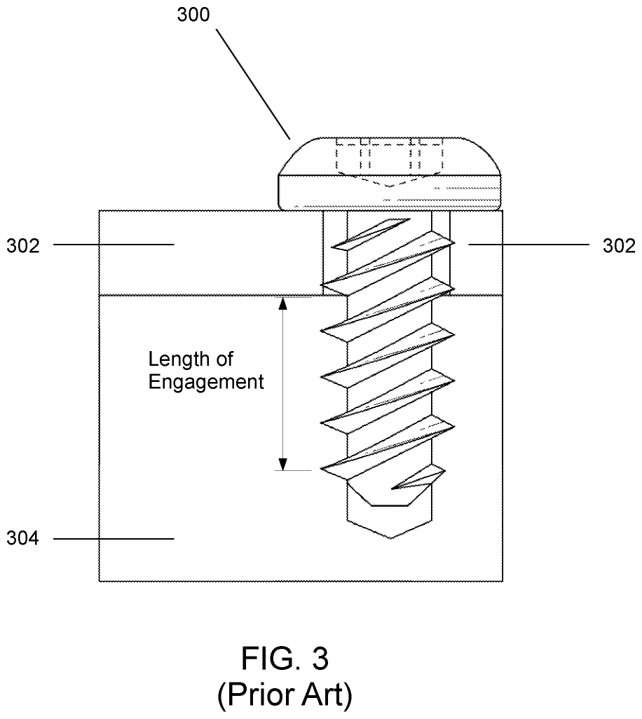

FIG. 4 illustrates a prior art chemical anchor.

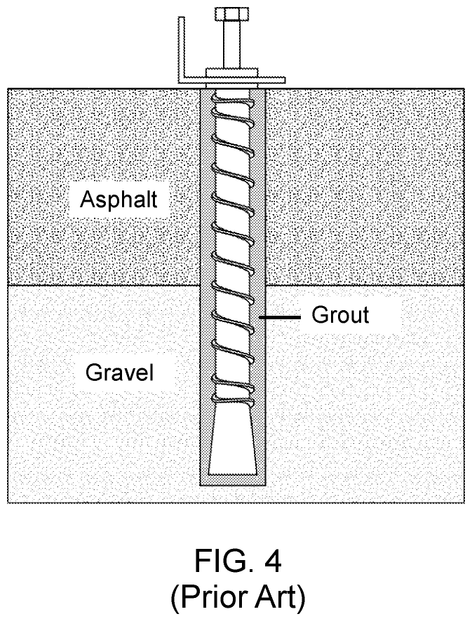

FIG. 5 illustrates an embodiment of an anchor and a screw in accordance with the principles disclosed herein.

FIG. 6 illustrates an embodiment of an anchor and a screw with example dimensions.

FIG. 7 illustrates an embodiment of an anchor in accordance with the principles disclosed herein.

The figures are only intended to facilitate the description of the principles disclosed herein. The figures do not illustrate every aspect of the principles disclosed herein and do not limit the scope of the principles disclosed herein. Other objects, features, and characteristics will become more apparent upon consideration of the following detailed description.

### DETAILED DESCRIPTION

A detailed illustration is disclosed herein. However, techniques, methods, processes, systems and operating structures in accordance with the principles disclosed herein may be embodied in a wide variety of forms and modes, some of which may be quite different from those disclosed herein. Consequently, the specific structural and functional details disclosed herein are merely representative.

None of the terms used herein, including “anchor” and “screw,” are meant to limit the application of the principles disclosed herein. Any reference to a screw is exemplary and intended to encompass a screw, bolt, or similar fastener comprising or configured to engage with a helical ridge. Other explicit and implicit definitions may also be included below.

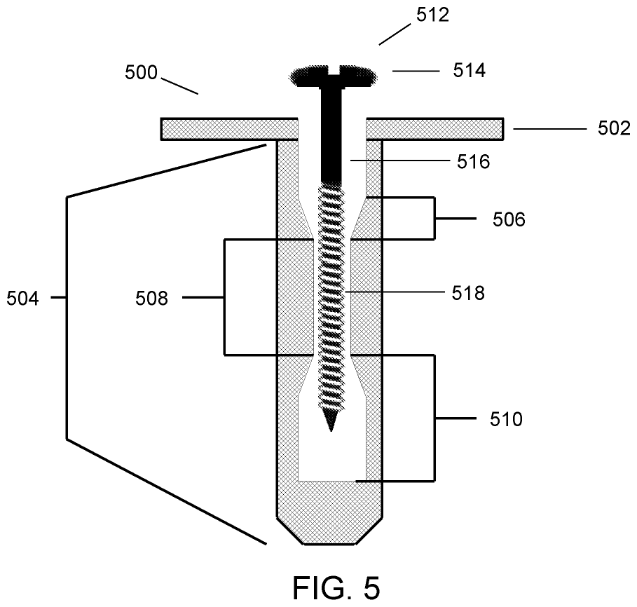

With reference to FIG. 5, a cross section of anchor 500 shows anchor head 502 and anchor body 504, which comprises a channel with counterbore opening 506, engagement area 508, and relief chamber 510. Screw 514 comprises screw head 514, non-threaded portion 516, and threaded portion 518.

The mouth of counterbore opening 506 has a diameter that matches the largest diameter of threaded portion 518 and thus guides screw 512 into anchor 500 on the center axis of the channel in the anchor. In some alternative embodiments, a counterbore opening (such as counterbore opening 506) is omitted.

The engagement area 508 is where screw 512 cuts its threaded portion 518 into the anchor's interior wall. The length of engagement area 508 should be chosen to suit the diameter of screw 512. For example, the Stanley Publication advises that the length of engagement should be 2 to 3 times the nominal screw diameter.

The relief chamber 510 allows the extra length of screw 512 to move without engaging in the anchor's interior wall. Thus, once the threaded portion 518 of screw 512 has reached the innermost point of engagement area 508, inserting screw 512 further into anchor 500 will not increase the engagement length. Thus, a maximum engagement length may be designed for a given anchor. Relief chamber 510 is shown with a counterbore transition where the chamber meets the engagement area 508, but in some alternative embodiments, a counterbore transition may be omitted.

Anchors according to the principles disclosed herein may be manufactured using any suitable process. In one example, manufacturing of an anchor comprises molding a solid core, then drilling out a narrow hole with the diameter of the engagement area, drilling out a larger hole from the top to create the top opening, and drilling out a larger hole from the bottom to create the relief chamber. A molded plug is then inserted into the bottom of the anchor and sealed, thereby securing the bottom of the anchor closed.

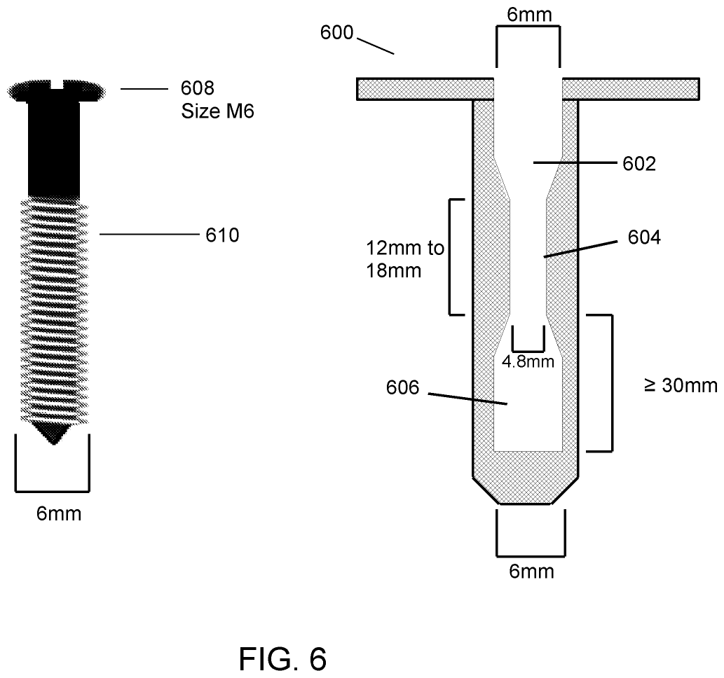

FIG. 6 depicts an example (not shown to scale) with dimensions for an anchor 600 and screw 608. Screw 608 is a size M6 screw, which has an outside diameter of the screw threads 610 of 6 mm. The mouth of counterbore opening 602 has a 6 mm diameter which matches the diameter of the screw threads 610. The engagement area 604 has a diameter of 4.8 mm and an engagement length of 12 mm to 18 mm (corresponding to 2 to 3 times the diameter of the 6 mm screw threads). The relief chamber 606 has a diameter of 6 mm and a length of 30 mm or more. In some embodiments, the relief chamber is 110 mm or more.

The principles disclosed herein may be used to produce anchors of various dimensions. For use in asphalt applications, it is recommended to use anchors configured to receive screws of size M4 up to size M30. An anchor configured to receive a screw smaller than a size M4 may be too weak for an asphalt surface that is driven, rolled, or walked on. At the high end, an anchor configured to receive a screw larger than a size M30 may be uneconomical or otherwise undesirable, as the weakness of the asphalt becomes a limiting factor makes it difficult to justify such a large bolt and large diameter hole.

An anchor as described herein may comprise any suitable material. Testing has shown that polycarbonate materials are particularly suitable. Compared to polycarbonate alone, an anchor formed of polycarbonate material with 10-30% glass demonstrates an increased ability to withstand large pull and shear forces, but also demonstrates an increased brittleness.

If water or other liquids enter the interior of an anchor, such as the relief chamber or engagement area of an anchor as disclosed herein, the water or other liquids may weaken the screw by, for example, causing it to rust. Thus, in some embodiments, the interior of the anchor is provided with a water-tight seal to prevent groundwater or other liquids from entering the interior of the anchor. The watertight seal may be naturally formed as a function of the anchor material, such as for anchors consisting of molded plastic. In some embodiments, a pliable washer may be used under the screw head to reduce or prevent water or other liquids from entering the interior of the anchor through the top.

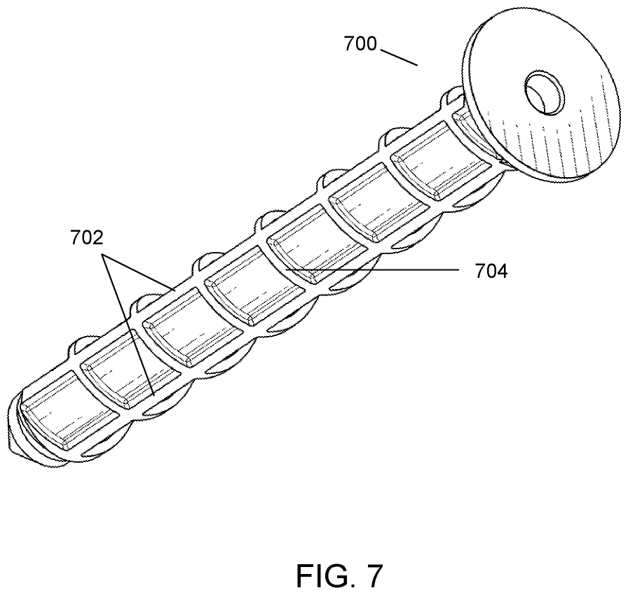

In some embodiments, an anchor as described herein may incorporate one or more substantially vertical structures on the exterior of the anchor body to better resist torque-out of the anchor from the surrounding material. In some embodiments, an anchor as described herein may incorporate one or more substantially horizontal structures on the exterior of the anchor body to better resist pull-out of the anchor from the surrounding material. Combinations of horizontal and vertical structures may be employed, and other suitable designs may be employed without departing from the principles disclosed herein. For example, FIG. 7 depicts anchor 700 which comprises vertical structures 702 and spiral structure 704.

A screw may be provided with an anchor or otherwise selected for use with an anchor. Preferably, a screw is chosen with a length that extends through the object(s) to be fastened and leaves enough length in the threaded area to engage with the full length of the engagement area of the anchor but not extend past the length of the relief chamber.

It is contemplated that a nail may be used with an anchor is accordance with the principles disclosed herein, for example in field applications that involve varying lengths of nails. Providing a relief chamber may reduce the overall effort required to drive the nail in.

The detailed description is not intended to be limiting or represent an exhaustive enumeration of the principles disclosed herein. It will be apparent to those of skill in the art that numerous changes may be made in such details without departing from the spirit of the principles disclosed herein.

What is claimed is:

1. An anchor, comprising:
an opening;
a relief chamber internal to the anchor; and
an engagement area between the opening and the relief chamber.

2. An anchor as in claim 1, comprising an anchor head.

3. An anchor as in claim 1, wherein the anchor comprises plastic.

4. An anchor as in claim 1, wherein the anchor comprises a water-tight body.

5. An anchor as in claim 1, further comprising a water-tight seal.

6. An anchor as in claim 1, further comprising one or more exterior structures.

7. An anchor, comprising:
a body comprising a channel, the channel comprising:
an engagement area with a first cross-sectional diameter; and
a relief chamber internal to the body, the relief chamber comprising a second cross-sectional diameter that is larger than the first cross-sectional diameter.

8. An anchor as in claim 7, comprising an anchor head.

9. An anchor as in claim 7, wherein the anchor comprises plastic.

10. An anchor as in claim 7, wherein the anchor comprises a water-tight body.

11. An anchor as in claim 7, further comprising a water-tight seal.

12. An anchor as in claim 7, wherein a cross-section of the engagement area is substantially cylindrical, and a cross-section of the relief chamber is substantially cylindrical.

13. An anchor kit, comprising:
an anchor comprising a channel, the channel comprising:
an engagement area with a first cross-sectional diameter;
a relief chamber with a second cross-sectional diameter that is larger than the first cross-sectional diameter;
a screw comprising:
a screw head;
a threaded portion;
wherein a cross-sectional diameter of the threaded portion of the screw is matched to the first cross-sectional diameter.

14. An anchor kit as in claim 13, wherein the anchor comprises an anchor head.

15. An anchor kit as in claim 13, wherein the anchor comprises plastic.

16. An anchor kit as in claim 13, wherein the anchor comprises a water-tight body.

17. An anchor kit as in claim 13, further comprising a water-tight seal.

18. An anchor kit as in claim 13, wherein the anchor comprises an opening with a third cross-sectional area that is smaller than the first cross-sectional area.

19. An anchor kit as in claim 13, wherein the anchor comprises one or more exterior structures.

20. An anchor kit as in claim 13, wherein the screw has a length selected to extend through one or more objects to be fastened, through the engagement area, and only partially into the relief chamber.
